(19) United States
(12) Patent Application Publication
(10) Pub. No.: US 2021/0327169 A1
(43) Pub. Date: Oct. 21, 2021

(54) Remote Vehicle Control System

(71) Applicant: Joseph Garcia, Denver, CO (US)

(72) Inventor: Joseph Garcia, Denver, CO (US)

(21) Appl. No.: 17/229,025

(22) Filed: Apr. 13, 2021

Related U.S. Application Data
(60) Provisional application No. 63/010,172, filed on Apr. 15, 2020.

(51) Int. Cl. G07C 5/08; H04B 1/3822; G05D 1/00; G07C 5/00

(52) U.S. Cl. CPC G07C 5/0808; H04B 1/3822; G07C 5/008; G07C 5/0825; G05D 1/0016

(57) ABSTRACT

A remote vehicle control system is provided. The system includes a transceiver housing having a wireless transceiver therein. The transceiver housing further includes a connector that can operably connect the transceiver housing to a vehicle control system having a plurality of subsystems. The transceiver housing is further in communication with an external device via the wireless transceiver. The external device further includes an application, wherein the application has a logic and interface that can selectively control the plurality of subsystems upon validation of a vehicle identification number associated with the vehicle control system.

### CROSS REFERENCE TO RELATED APPLICATIONS

This application claims the benefit of U.S. Provisional Application No. 63/010,172 filed on Apr. 15, 2020. The above identified patent application is herein incorporated by reference in its entirety to provide continuity of disclosure.

### BACKGROUND OF THE INVENTION

The present invention relates to remote vehicle control systems. More particularly, the present invention pertains to a remote vehicle control system that allows a user to adjust various vehicle systems remotely upon verification of a vehicle identification number, while also receiving and cataloguing diagnostic information associated with the vehicle.

Many individuals have difficulty keeping track of required maintenance of their vehicles. Failing to properly maintain a vehicle can risk the driver's safety or otherwise decrease the vehicle's efficiency of operation, which can lead to increased expense. For example, as the various vehicle components degrade, fuel efficiency may decrease, resulting in more frequent refueling and increased cost. Additionally, many consumer alerts, such as recalls, go unnoticed by many drivers, which can pose a significant safety risk. Furthermore, vehicles have a variety of systems that a user can control to increase user convenience or comfort, such as heating, air conditioning, radio, automatic door locks, and the like, however each of these systems must typically be operated while within the vehicle itself. Often, a user may desire to prepare the vehicle for future operation ahead of entering the vehicle, in order to ensure maximum convenience and comfort. Alternatively, users may not have access to their vehicle keys, whether misplaced or locked inside the vehicle, which can make such preparations impossible. Therefore, a device that alerts a user to various vehicle maintenance requirements while also allowing a user to remotely control various vehicle systems, such as through an electronic device, is desired.

In light of the devices disclosed in the known art, it is submitted that the present invention substantially diverges in design elements from the known art and consequently it is clear that there is a need in the art for an improvement to existing remote vehicle control systems. In this regard, the instant invention substantially fulfills these needs.

### SUMMARY OF THE INVENTION

In view of the foregoing disadvantages inherent in the known types of remote vehicle control systems now present in the known art, the present invention provides a remote vehicle control system wherein the same can be utilized for providing convenience for the user when remotely adjusting vehicle systems associated with a particular vehicle identification numbers and receiving updates and vehicle diagnostic alerts.

The present system comprises a transceiver housing having a wireless transceiver therein. The transceiver housing comprises a connector configured to operably connect the transceiver housing to a vehicle control system having a plurality of subsystems. The transceiver housing is in communication with an external device vis the wireless transceiver. The external device further includes an application thereon, the application comprising a logic and interface configured to selectively control the plurality of subsystems upon validation of a vehicle identification number associated with the vehicle control system. In some embodiments, the application is further configured to receive voice inputs from a microphone disposed within the external device, wherein the voice inputs are configured to selectively control the plurality of subsystems.

In another embodiment, the transceiver housing further comprises an indicator light thereon, the indicator light configured to illuminate when actively communicating with the external device. In other embodiments, each subsystem of the plurality of subsystems is selected from a group consisting of: an air conditioning system, a heating system, a radio, a lighting system, an engine system, a power window system, a heated seat system, a cooled seat system, a and a windshield wiper system. In yet another embodiment, the transceiver housing operably connects to a vehicle diagnostic system, wherein the transceiver housing transmits vehicle diagnostic information to the external device to be displayed by the application. In some embodiments, the vehicle diagnostic information is selected from a group consisting of: current tire pressure, optimal tire pressure, current oil pressure, optimal oil pressure, current fuel level, optimal fuel level, engine alerts, mileage, registration information, and active recalls. In another embodiment, the application is configured to provide an alert when the vehicle diagnostic information falls outside an optimal threshold. In other embodiments, the connector comprises a USB connector configured to removably secure within a USB port of a vehicle dashboard. In yet another embodiment, the interface comprises a plurality of controls, wherein a control of the plurality of controls is associated with a subsystem of the plurality of subsystems.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the of the transceiver housing of the remote vehicle control system.

FIG. 2 shows a schematic diagram of an embodiment of the remote vehicle control system.

FIG. 3A shows a perspective view of a system control interface of an embodiment of the remote vehicle control system.

FIG. 3B shows a perspective view of an embodiment of a system diagnostic interface of the remote vehicle control system.

FIG. 3C shows a perspective view of an embodiment of a GPS interface of the remote vehicle control system.

### DETAILED DESCRIPTION OF THE INVENTION

Reference is made herein to the attached drawings. Like reference numerals are used throughout the drawings to depict like or similar elements of the remote vehicle control system. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “electronic device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

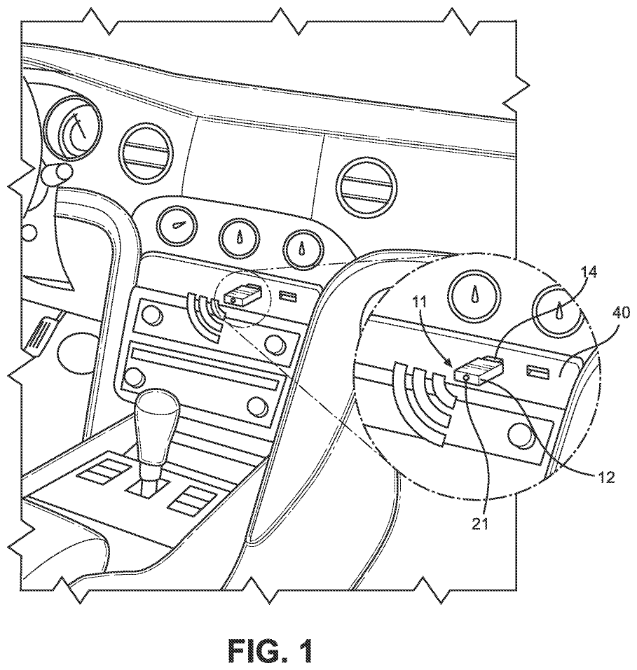

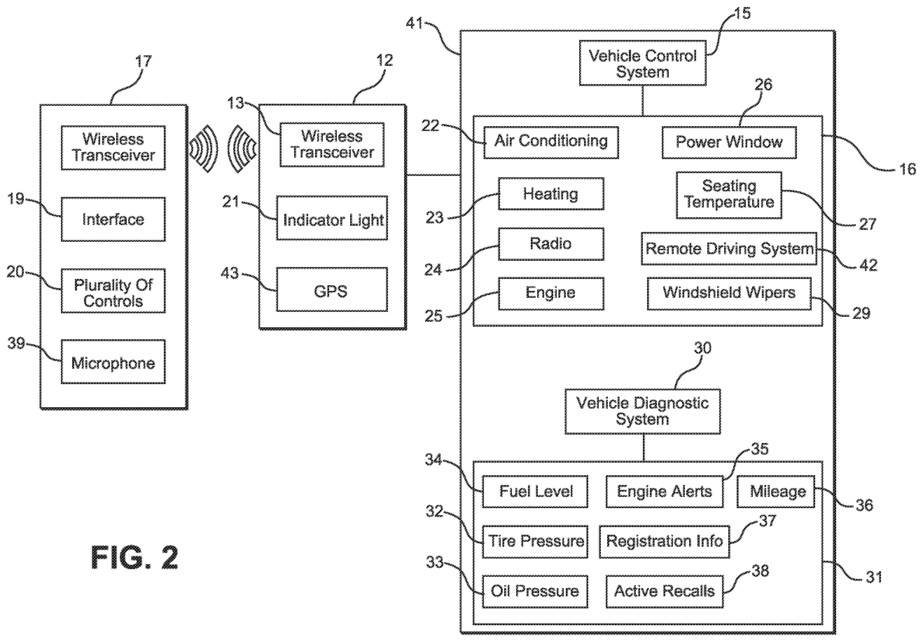

Referring now to FIG. 1, there is shown a perspective view of an embodiment of the of the transceiver housing of the remote vehicle control system. The remote vehicle control system 11 comprises a transceiver housing 12 having a wireless transceiver (as shown in FIG. 2, 13) therein. The transceiver housing 12 further comprises a connector 14, wherein the connector 14 is configured to operably connect the transceiver housing 12 and the internal components thereof to a vehicle control system. In the illustrated embodiment, the connector 14 is removably securable within a vehicle dashboard 40, via an associated port, wherein the port provides access to various vehicle controls, diagnostic systems, and the like. For example, the connector 14 can operably connect the transceiver housing 12 to any electronic control unit (ECU) or vehicle control unit (VCU) within the vehicle.

In the illustrated embodiment, the connector 14 comprises a USB connection, however, in alternate embodiments, other connection mechanisms capable of operably connecting the transceiver housing 12 to a vehicle control system are contemplated. For example, in an alternate embodiment, the connector 14 comprises a direct connection to a diagnostic link connector of an associated vehicle such that the transceiver housing 12 is permanently installed and connected to various on board vehicle components as further described elsewhere herein. In this manner, the transceiver housing 12 can be hidden from view beneath a vehicle dashboard, allowing the remote vehicle control system 11 to provide vehicle diagnostic information in an unobtrusive manner. In the shown embodiment, the transceiver housing 12 further comprises an indicator light 21 thereon. The indicator light 21 is configured to selectively illuminate when the transceiver housing 12 is actively transmitting or receiving data. In this manner, the user can readily identify when a proper connection has been made with the vehicle control system and an associated external device (as shown in FIG. 2, 17).

Referring now to FIG. 2, there is shown a schematic diagram of an embodiment of the remote vehicle control system. The transceiver housing 12 is further operably connected to an external device 17. In one embodiment, the external device and the transceiver housing are connected via a paired connection between the wireless transceivers 13 disposed in each of the transceiver housing 12 and the external device 17. The external device 17 comprises an application thereon, the application having a logic and interface 19, wherein the logic is configured to selectively control a plurality of subsystems 16 associated with a vehicle control system 15 upon validation of a vehicle identification number (VIN) associated with a vehicle 41. The interface 19 further includes a plurality of controls 20, wherein each control of the plurality of controls 20 corresponds to a subsystem of the plurality of subsystems 16 such that the user can selectively control or adjust the plurality of subsystems 16 remotely via the external device 17. In some embodiments, the plurality of subsystems 16 are further selectively controllable via voice puts associated with each subsystem, wherein the voice inputs are received via a microphone 39 disposed within the external device 17. In this manner, the user can control the various vehicle subsystems of the plurality of subsystems 16 in a hands-free manner, thereby maximizing safety to the user when driving. In the illustrated embodiment, the transceiver housing 12 further comprises a GPS system 43 therein, wherein the GPS system 43 is configured to transmit the location of the transceiver housing 12 to the external device 17. In this manner, the user can track the location of the transceiver housing 12, as well as the location of the vehicle that the transceiver' housing 12 is operably connected to.

Once the transceiver housing 12 is connected to the vehicle 41 via the connector, the transceiver housing 12 is operably connected to a vehicle control system 15 of the vehicle 41. The vehicle control system 15 comprises a plurality of subsystems 16, wherein each subsystem of the plurality of subsystems 16 comprises a separate function that the vehicle control system 15 can adjust or control upon user input. In the shown embodiment, the plurality of subsystems 16 includes air conditioning systems 22, heating systems 23, vehicle radio 24, engine control 25, remote driving systems 42, power window systems 26, seating temperature controls 27, and windshield wiper systems 29. In alternate embodiments, other frequently adjustable and remotely controllable vehicle systems can be included in the vehicle control system 15, such as, but not limited to vehicle locks, vehicle lights, both internal and external, trunk access, hood release, and the like. In this manner, once operably connected to the vehicle control system 15, the user can wirelessly transmit control inputs from the external device 17 as previously described. This allows a user to selectively adjust various subsystems of the plurality of subsystems 16 remotely. For example, the user can remotely adjust vehicle temperature via inputs to either the air conditioning system 22 or the heating system 23, activate, select a station to play, or adjust the volume of the vehicle radio 24, remotely start the vehicle engine via engine control 25, open or close vehicle windows by varying degrees via power window controls 26, adjust vehicle seat temperatures via seating temperature systems 27, and activate and control the rate of operation of windshield wipers via the windshield wiper system 29. When actively transmitting or receiving information, the indicator light 21 of the transceiver housing 12 can illuminate to inform the user of the active connection.

In the illustrated embodiment, the vehicle control system 15 further includes a remote driving system 42 configured to automatically drive the vehicle to a desired location. For example, the remote driving system 42 can be utilized to automatically park the vehicle, or alternatively, summon the vehicle to the location of the user via a valet mode. In this manner, the user can input a command on the external device 17 to activate the remote driving system 42 to cause the vehicle to drive to a location associated with the external device 17. In some such embodiments, the remote driving system 42 is further operably linked to the GPS system 43 to plot a route between the external device 17 and the vehicle to allow the vehicle to operate entirely within existing marked roadways and vehicle accessible locations.

In the illustrated embodiment, the transceiver housing 12 further operably connects to a vehicle diagnostic system 30 via the connection to the vehicle 41. The vehicle diagnostic system 30 compiles a variety of vehicle diagnostic information 31 either detected via a plurality of vehicle sensors or received from a remote location consistently monitored by the vehicle diagnostic system 30. For example, some vehicle diagnostic information 31 comprises vehicle specific states, including, but not necessarily limited to tire pressure 32, oil pressure 33, fuel level 34, engine alerts 35, and mileage 36, wherein the current status of each of these vehicle diagnostic information 31 is catalogued via detection via a plurality of associated sensors tasked with monitoring such systems. In some such embodiments, both current and optimal levels for each diagnostic state is identified, such that a user can be informed of when each diagnostic state falls outside of a desired threshold. In this manner, the user is aware of necessary maintenance that must be performed to ensure the vehicle 41 operates in an optimal manner. In some embodiments, the external device 17 is configured to emit an audible alert when a diagnostic state falls outside of a desired threshold to further alert the user. Similarly, additional external information can be retrieved, catalogued, and maintained by the vehicle diagnostic system 30, such as vehicle registration information 37 and manufacturer mandated recalls 38. This external information can be collected for display to the user via the external device 17.

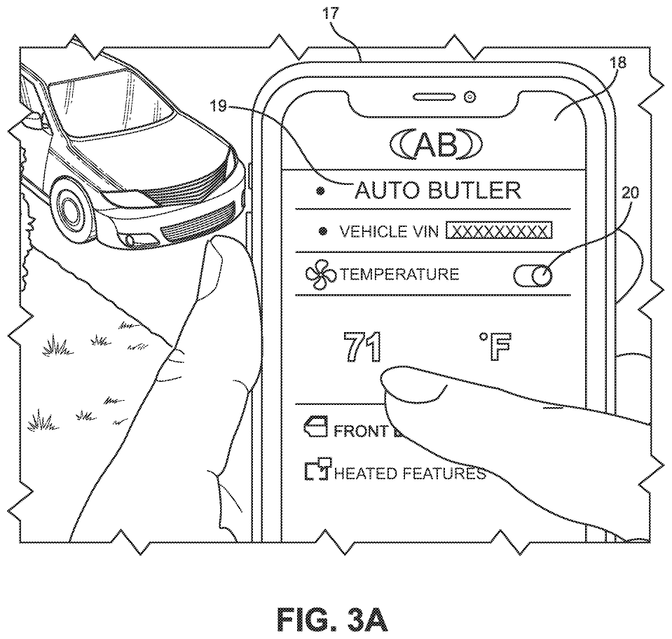

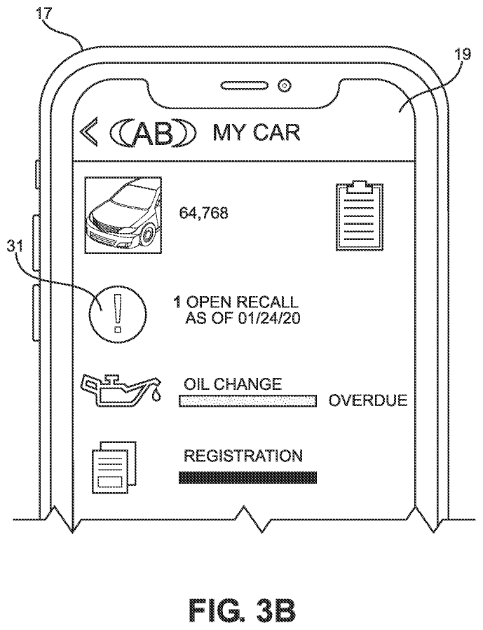

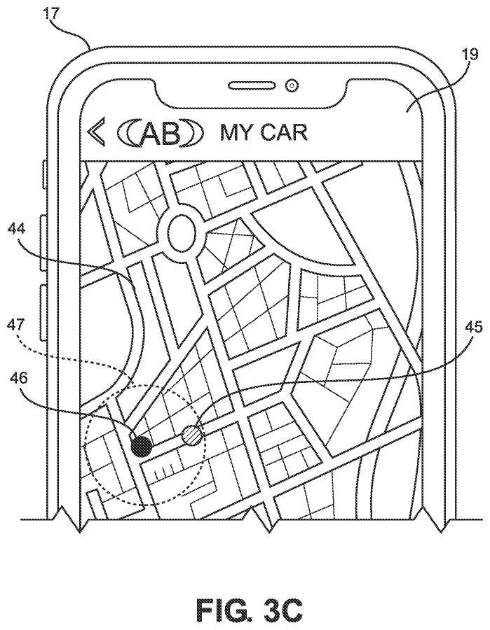

Referring now to FIGS. 3A, 3B, and 3C, there is shown a perspective view of a system control interface of an embodiment of the remote vehicle control system, a perspective view of a system diagnostic interface of an embodiment of the remote vehicle control system, and a perspective view of an embodiment of a GPS interface of the remote vehicle control system, respectively. In the illustrated embodiment, the external device 17 comprises a smartphone, however, in alternate embodiments, the external device 17 can comprise a variety of electronic devices, such as tablets, laptops, desktop computers, and the like. In the shown embodiment of FIG. 3A, the external device 17 further includes the application 18 thereon, wherein the application operates via an interface 19 displayed on the external device 17. In order to provide security to the user, the logic of the application 18 is configured to prevent access and control of the vehicle subsystems until the VIN of the associated vehicle is entered and validated against a stored VIN. In this manner, undesired users are prevented from controlling the variety of subsystems of the vehicle. The interface 19 includes a plurality of controls 20, wherein each of the plurality of controls 20 corresponds to a particular subsystem of the plurality of subsystems. In this manner, the user can readily and efficiently control or adjust each of the vehicle subsystems remotely. In the shown embodiment of FIG. 3A, the plurality of controls 20 include vehicle temperature controls, such that the user can adjust a vehicle temperature.

In the illustrated embodiment of FIG. 3B, the interface 19 further comprises a vehicle diagnostics display, wherein the vehicle diagnostic information 31 is displayed for the user's examination. In some such embodiments, the application 18 is configured to emit an audible alert upon any vehicle diagnostic information 31 falling outside of a desired threshold range. For example, should oil pressure fall below a desired pressure, the application is configured to emit an audible alert. Similarly, upon receipt of an active recall or impending registration deadline, the application 18 can further provide the user an audible alert. In one use, the user can open the application 18 on their external device 17 and enter the VIN of the vehicle the user wishes to control. The application 18 will then validate the VIN with a transceiver housing affixed to the associated vehicle, such that if the entered VIN fails to match the VIN of the vehicle the transceiver housing is connected to, the user is prevented from accessing vehicle diagnostic information 31 or control vehicle subsystems. Once validated, the interface 19 displays a plurality of controls 20 associated with the vehicle control system, such that the user can selectively control each subsystem remotely. The user can then further view various vehicle diagnostic information 31 and alerts via the interface 19 to remain informed of upcoming maintenance deadlines or requirements. In this manner, the user can readily and efficiently monitor and control their vehicle remotely.

In the shown embodiment of FIG. 3C, the application 18 is further configured to display a map 44 of the vicinity around the external device 17 to be used with the GPS system. The map 44 further comprises a user indicator 46 configured to display the relative location of the external device 17, and therefore, the location of the user operating the application 18. In the shown embodiment, the map 44 further comprises a vehicle indicator 45 highlighting the location of the vehicle as determined by the GPS system within the transceiver housing. In this manner, the user can visualize the location of the vehicle relative to themselves and plot a route for the vehicle to travel upon activation of the remote driving system. In some embodiments, the remote driving system is further limited by an operating radius 47 positioned about the user indicator 46, wherein the remote driving system can only be activated if the vehicle is within the operating radius 47. In this manner, the distance an automated vehicle is traveling can be limited as desired by the user or required by law. In further embodiments, the user can adjust the size of the operating radius 47 to via control inputs to the application 18.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A remote vehicle control system, comprising:
a transceiver housing having a wireless transceiver therein;
wherein the transceiver housing comprises a connector configured to operably connect the transceiver housing to a vehicle control system having a plurality of subsystems;
wherein the transceiver housing is in communication with an external device via the wireless transceiver;
wherein the external device further includes an application thereon, the application comprising a logic and interface configured to selectively control the plurality of subsystems upon validation of a vehicle identification number associated with the vehicle control system.

2. The remote vehicle control system of claim 1, wherein the transceiver housing further comprises an indicator light thereon, the indicator light configured to illuminate when actively communicating with the external device.

3. The remote vehicle control system of claim 1, wherein each subsystem of the plurality of subsystems is selected from a group consisting of: an air conditioning system, a heating system, a radio, a lighting system, an engine system, a remote driving system, a power window system, a heated seat system, a cooled seat system, and a windshield wiper system.

4. The remote vehicle control system of claim 1, wherein the transceiver housing operably connects to a vehicle diagnostic system, wherein the transceiver housing transmits vehicle diagnostic information to the external device to be displayed by the application.

5. The remote vehicle control system of claim 4, wherein the vehicle diagnostic information is selected from a group consisting of: current tire pressure, optimal tire pressure, current oil pressure, optimal oil pressure, current fuel level, optimal fuel level, engine alerts, mileage, registration information, and active recalls.

6. The remote vehicle control system of claim 4, wherein the application provides an alert when the vehicle diagnostic information falls outside an optimal threshold.

7. The remote vehicle control system of claim 1, wherein the connector comprises a USB connector configured to removably secure within a USB port of a vehicle dashboard.

8. The remote vehicle control system of claim 1, wherein the interface comprises a plurality of controls, wherein a control of the plurality of controls is associated with a subsystem of the plurality of subsystems.

9. The remote vehicle control system of claim 1, wherein the interface comprises a map configured to display the location of the transceiver housing via a GPS system disposed within the receiver housing and operably connected to the external device by the wireless transceiver.

10. The remote vehicle control system of claim 3, wherein the remote driving system is configured to be limited by a maximum operating radius and maximum speed setting selected by the user.

11. A remote vehicle control system, comprising:
a transceiver housing having a wireless transceiver therein;
wherein the transceiver housing comprises a connector configured to operably connect the transceiver housing to a vehicle control system having a plurality of subsystems;
wherein the transceiver housing is in communication with an external device via the wireless transceiver;
wherein the external device further includes an application thereon, the application comprising a logic and interface configured to selectively control the plurality of subsystems upon validation of a vehicle identification number associated with the vehicle control system;
wherein the application is configured to receive voice inputs from a microphone disposed within the external device, the voice inputs configured to selectively control the plurality of subsystems.

12. The remote vehicle control system of claim 11, wherein the transceiver housing further comprises an indicator light thereon, the indicator light configured to illuminate when actively communicating with the external device.

13. The remote vehicle control system of claim 11, wherein each subsystem of the plurality of subsystems is selected from a group consisting of: an air conditioning system, a heating system, a radio, a lighting system, an engine system, a remote driving system, a power window system, a heated seat system, a cooled seat system, and a windshield wiper system.

14. The remote vehicle control system of claim 11, wherein the transceiver housing operably connects to a vehicle diagnostic system, wherein the transceiver housing transmits vehicle diagnostic information to the external device to be displayed by the application.

15. The remote vehicle control system of claim 14, wherein the vehicle diagnostic information is selected from a group consisting of: current tire pressure, optimal tire pressure, current oil pressure, optimal oil pressure, current fuel level, optimal fuel level, engine alerts, mileage, registration information, and active recalls.

16. The remote vehicle control system of claim 14, wherein the application provides an alert when the vehicle diagnostic information falls outside an optimal threshold.

17. The remote vehicle control system of claim 11, wherein the connector comprises a USB connector configured to removably secure within a USB port of a vehicle dashboard.

18. The remote vehicle control system of claim 11, wherein the interface comprises a plurality of controls, wherein a control of the plurality of controls is associated with a subsystem of the plurality of subsystems.

19. The remote vehicle control system of claim 11, wherein the interface comprises a map configured to display the location of the transceiver housing via a GPS system disposed within the receiver housing and operably connected to the external device by the wireless transceiver.

20. The remote vehicle control system of claim 13, wherein the remote driving system is configured to be limited by a maximum operating radius and maximum speed setting selected by the user.
